(19) United States
(12) Patent Application Publication
(10) Pub. No.: US 2008/0257875 A1
(43) Pub. Date: Oct. 23, 2008

(54) Wire Guide

(76) Inventor: Marcel Francesco De Keizer, Rijswijk (NL)

Correspondence Address: Olson & Cepuritis, LTD., 20 NORTH WACKER DRIVE, 36TH FLOOR, CHICAGO, IL, 60606, US

(21) Appl. No.: 11/795,363

(22) PCT Filed: Jan. 13, 2006
(86) PCT No.: PCT/NL2006/000021

§ 371 Date: Jan. 31, 2008

(30) Foreign Application Priority Data
Jan. 17, 2005 (NL) 1028049

(51) Int. Cl. B23K 9/28

(52) U.S. Cl. 219/137.44; 226/196.1

(57) ABSTRACT

The invention relates to wire guide (1) for a thin metal wire (14), which wire guide comprises a flexible sheath (2) through which the metal wire (14) can be passed to a welding gun or a gun for applying a metallic coating or the like to an object. Spaced-apart guide rollers for the metal wire are provided within the sheath.

The invention relates to a wire guide for a thin metal wire, which wire guide comprises a flexible sheath through which the metal wire can be passed to a welding gun or a gun for applying a metallic coating or the like to an object.

In prior art constructions of wire guides, such as the wire guides used with welding guns or guns for applying a metallic coating to an object by spraying the metal wire material, the flexible sheath has an internal diameter which at least substantially corresponds to the external diameter of the metal wire to be moved through the sheath. The metal wire is driven by means of pusher rolls disposed near the end of the sheath remote from the gun, which engage the outer circumference of the metal wire, and/or by means of driven pinch rolls disposed near the gun that engage the metal wire.

Usually said sheaths are bent in various directions during operation, both when the gun is manually operated and when the gun is mounted on a robot, for example.

In practice it has become apparent that moving the metal wire through the sheath becomes very difficult if not altogether impossible as a result of the friction that occurs between the outer circumference of the metal wire and the inner circumference of the flexible sheath, especially after some time of service.

The object of the invention is to obviate or eliminate this drawback of the wire guides that have been used so far, which has been known for several decades already.

According to the invention this object can be achieved in that spaced apart guide rollers for the metal wire are provided within the sheath.

By supporting and guiding the metal wire by means of guide rollers in the sheath of the wire guide, the phenomenon of friction that opposes the movement of the metal wire through the sheath is eliminated practically entirely.

It is noted that the term guide rollers as used in the present application is to be given a broad interpretation, and that it is considered to include also thin disc-shaped or wheel-shaped means, for example, as well as spherical means.

The invention will be explained in more detail below with reference to an embodiment of the construction according to the invention as schematically shown in the appended figures.

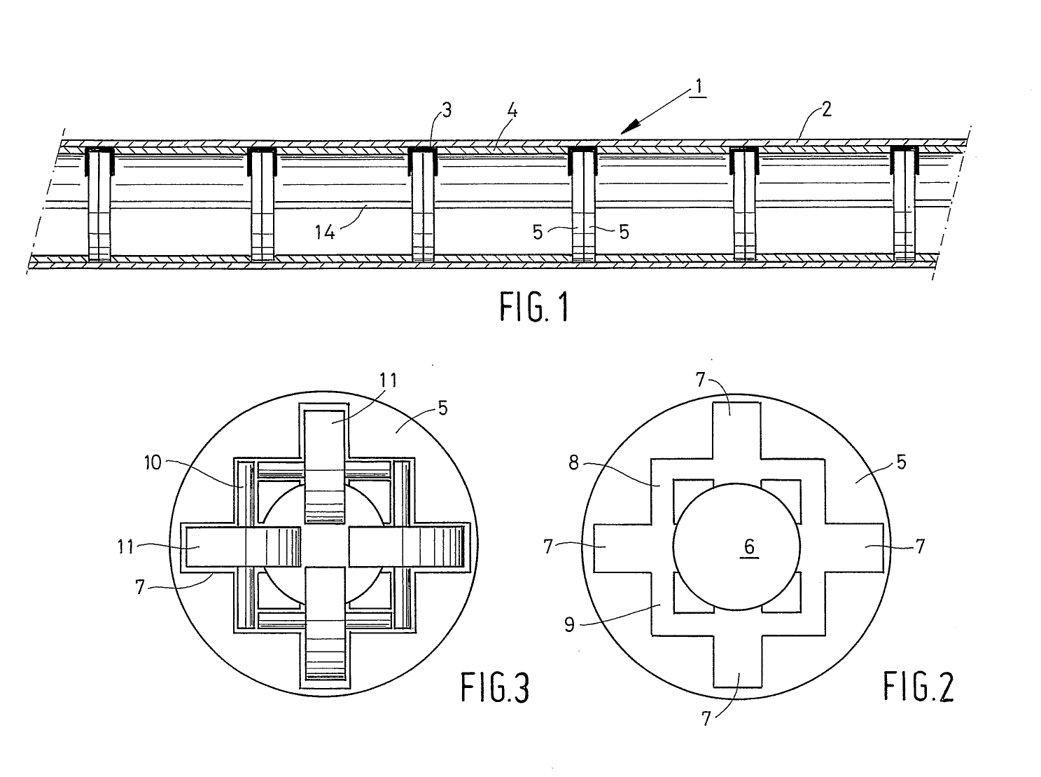

FIG. 1 shows part of a wire guide according to the invention.

FIG. 2 is a view of a disc-shaped element, which is provided with recesses for accommodating guide rollers and shafts that support guide rollers.

FIG. 3 is a view corresponding to FIG. 2, which shows the guide rollers and shafts that support the guide rollers.

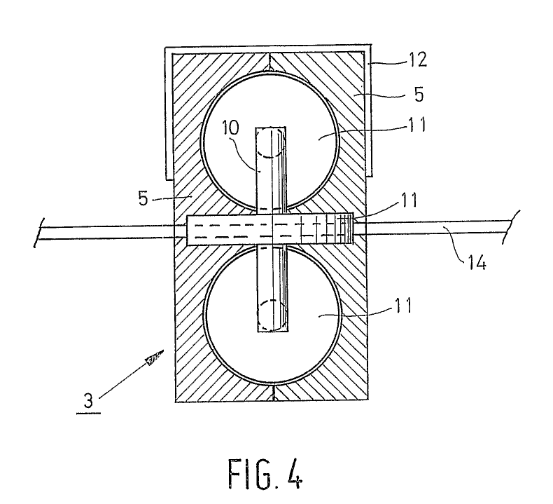

FIG. 4 shows an assembly of two disc-shaped elements that support guide rollers, which are interconnected by means of a clamping element.

FIG. 1 schematically shows a wire guide 1, which comprises a sheath or hose 2 made of a flexible material, for example a plastic or the like. Arranged within the sheath 2 are regularly spaced-apart supporting elements 3, whose construction will be explained in more detail hereinafter. The supporting elements are held in spaced-apart relationship by sheath-like or hose-like fillers 4 made of a flexible material, whose outer circumference corresponds to the inner circumference of the sheath 2.

Each supporting element 3 comprises two identically constructed disc-shaped elements 5. Each disc-shaped element 5 is provided with a central passage 6. Four recesses 7 formed in the disc-shaped element 5 join the passage 6, which recesses are staggered through successive angles of 90° with respect to each other in the illustrated embodiment. Two aligned grooves 8 and 9 join the opposing sides of each recess 7, with the grooves that join the various recesses 7 forming a full square, as will be apparent in particular from FIG. 2.

The grooves 8 and 9 are of semicircular section. The grooves 8 and 9 located on either side of a recess 7 function to receive the ends of a shaft 10 to which a guide roller or guide wheel 11 is mounted, which guide roller or guide wheel 11 is partially accommodated in the recess 7 and extending partially into the passage 6, as will be apparent from FIG. 3.

In FIG. 3, the shafts 10 are shown to be accommodated in the grooves 8 and 9 with some play for the sake of clarity.

To form a supporting element 3, two disc-shaped elements 5 are placed with their sides provided with the recessed parts 7-9 into abutment with each other, thereby retaining the shafts 10 in the grooves 8 and 9 of the two abutting disc-shaped elements 5, so that said shafts 10 will be freely rotatable in the bores formed by the paired grooves 8 and 9 of the two disc-shaped elements 5. The guide rollers or guide wheels 11 are freely rotatable in the recesses 7 in that situation. The disc-shaped elements 5, which are preferably made of a suitable plastic having a low coefficient of friction, are interconnected by means of a U-shaped bracket 12 that has been moved over the disc-shaped elements 5 (FIG. 4). The supporting elements 3 thus formed of two disc-shaped elements 5 and the shafts 10 and guide rollers 11 supported therein can now be moved one after another into the sheath 2, with the interposition of the fillers 4.

A metal wire 14 to be passed through the wire guide 1 will now be passed through the passages 6 in the supporting elements, being supported in the centre of the wire guide 1 by the facing boundary surfaces of the guide rollers 11. Since said guide rollers 11 are freely rotatable within the supporting elements 3, said guide rollers 11 will hardly resist the movement in longitudinal direction of the metal wire 14 through the wire guide 1.

Variations and/or additions to the embodiment of the wire guide 1 as described above are possible, of course. Thus it will be possible, for example, to construct a supporting element 3 in the form of a ball cage supporting a few balls or the like.

1. A wire guide for a thin metal wire, which wire guide comprises a flexible sheath through which the metal wire can be passed to a welding gun or a gun for applying a metallic coating or the like to an object, characterized in that spaced-apart guide rollers for the metal wire are provided within the sheath.

2. A wire guide according to claim 1, characterized in that supporting elements are arranged in spaced-apart relationship in the wire guide, which supporting elements support rollers, which rollers are freely rotatable about axes of rotation that intersect the longitudinal axis of the wire guide perpendicularly.

3. A wire guide according to claim 2, characterized in that four guide rollers are disposed in a supporting element, which guide rollers are staggered through successive angles of 90° with respect to each other, in such a manner that the guide rollers define a passage between them for passing a metal wire therethrough.

4. A wire guide according to claim 2 or 3, characterized in that a supporting element comprises two disc-shaped elements that abut against each other, the facing sides of which elements are provided with recesses for the guide rollers and the shafts that rotatably support the guide rollers in the supporting elements.

5. A welding gun for applying a metallic coating to an object, characterized in that a wire guide according to any one of the claims 1-4 is connected to said gun.
